(19) United States
(12) Patent Application Publication
(10) Pub. No.: US 2017/0365966 A1
(43) Pub. Date: Dec. 21, 2017

(54) Interchangeable Lamp Fixtures

(71) Applicants: Reed GILLETTE, Portland, OR (US); Richard GOETTER, Kirtland, OH (US)

(72) Inventors: Reed GILLETTE, Portland, OR (US); Richard GOETTER, Kirtland, OH (US)

(73) Assignee: RG Wire Solutions LLC, Tigard, OR (US)

(21) Appl. No.: 15/627,370

(22) Filed: Jun. 19, 2017

Related U.S. Application Data
(60) Provisional application No. 62/352,488, filed on Jun. 20, 2016.

(51) Int. Cl. H01R 33/00

(52) U.S. Cl. CPC H01R 33/00

(57) ABSTRACT

Reversible mounting systems offering mechanical support and electrical connections for light fixtures include a fixed, hard-wired portion that is typically installed on a wall or ceiling; and a connecting element configured to engage the fixed portion and to connect electrically thereto when so engaged. The connecting element may further include a light fixture or a flexible conducting cable to interconnect the connecting element and a remotely-located, suspended light fixture. Other features and characteristics are described and claimed.

### CONTINUITY AND CLAIM OF PRIORITY

This is an original U.S. patent application that claims priority to U.S. provisional patent application no. 62/352,488 filed 20 Jun. 2016.

### FIELD

The invention relates generally to interchangeable electrical components. More specifically, the invention relates to lamps equipped with removeable connecters that can be interchanged on a common base.

### BACKGROUND

Electrically-operated appliances and devices have been common in homes and offices for many decades. These devices may be generally categorized by the permanence of their connection: some devices, like water heaters and air conditioners, are “hard wired:” connected more-or-less permanently to their power sources and not intended to be disconnected or moved; while others, like hair dryers and coffee makers, are “plugged in:” connected using a reversible connector and often removed, moved or stored while not in use. (It is appreciated that some large appliances, such as refrigerators, washers, dryers and even ovens, may be connected via a plug-in cord and receptacle, notwithstanding that these plugs are rarely disconnected and the appliances almost never moved.)

Plug-in devices offer convenience and flexibility to users who may not have the skills or knowledge to safely disconnect and move a hard-wired appliance. The receptacles that accept a plug-in device are usually installed at convenient locations and hard-wired to electrical mains by a qualified electrician, while the naïve user can plug in any needed device at any receptacle location.

Wall and ceiling electrical fixtures have typically been of the hard-wired type. Electrical service is provided to a suitably-located “junction box,” and a light fixture such as a sconce or pendant is connected both electrically and mechanically thereto—both connections are more-or-less permanent, in that they cannot easily be altered by someone with little or no understanding of electrical safety (in some jurisdictions, such modifications may only be made by qualified contractors). The end user's role is limited to replacing failed light bulbs in these fixtures.

Because of the significant impact of lighting on the appearance and utility of living spaces (including the color, temperature and quality of light, as well as the aesthetic design of the light fixtures), systems and apparatus to allow an unsophisticated user to control more aspects of installed lighting, may be of substantial value in this field.

### SUMMARY

Embodiments of the invention are multi-part interlocking structures that permit safe, reversible interconnections providing both mechanical support and electrical connection, suitable for installing and replacing lighting fixtures on walls and ceilings.

### BRIEF DESCRIPTION OF DRAWINGS

FIG. 1 is an overview drawing of an embodiment in relation to a typical installation environment.

FIG. 2 shows an embodiment whose components are partially engaged.

FIG. 3 shows an exploded view of components of an embodiment.

FIG. 4 shows front and back views of a base plate of an embodiment of the invention.

FIG. 5 shows front and back views of a mating plate corresponding to the base plate of FIG. 2.

FIG. 6 shows the mating features of another embodiment of the invention.

FIG. 7 is a block diagram showing several functional components that may be present in an embodiment.

FIG. 8 shows example light fixtures with mating plates according to an embodiment.

FIG. 9 shows a sample cover plate.

### DETAILED DESCRIPTION

Embodiments of the invention comprise a fixed mounting plate (a “base” plate) having mechanical support features and electrical contacts that may be hard-wired to a source; and a removable mating plate having complementary support features to couple to the mechanical support features, and electrical contacts positioned to couple when the mating plate is engaged to the base plate. The mating plate may further comprise a lamp fixture coupled closely thereto, or a flexible multi-conductor cable for connection to a remote fixture (the cable may provide support and power for a pendant lamp, for example). Various features, arrangements and details of embodiments are described and claimed below.

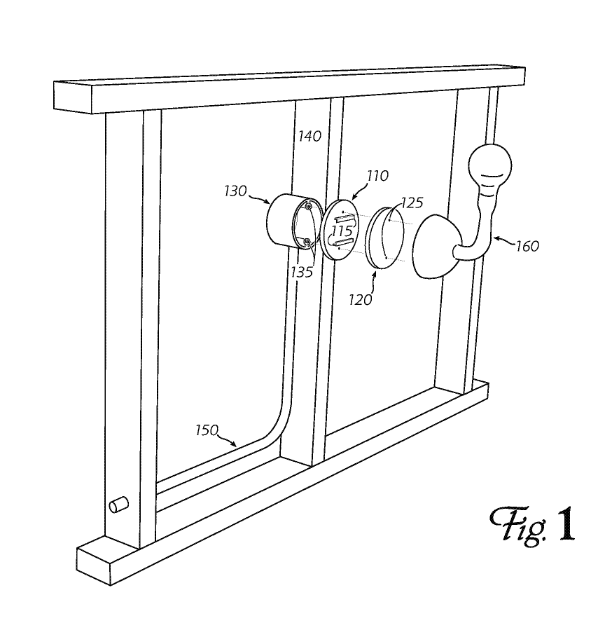

FIG. 1 shows a complete, exemplary embodiment in a typical installation environment. The embodiment comprises a base plate 110 and a mating plate 120. Base plate iio is secured to a prior-art junction box 130, which is installed in a suitable location, such as secured to a stud 140, or a joist, rafter or other structural member. Electrical conductors passing through conduit 150 carry power from a source such as a transformer, breaker panel or fuse box (not shown) to the junction box 130. In some embodiments, additional conductors may carry low-voltage control or communications signals to the junction box.

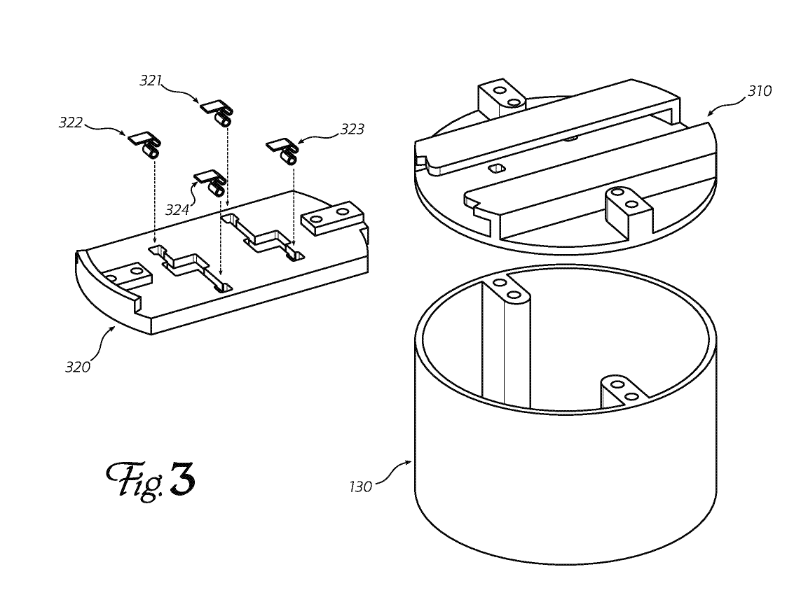

As described below, base plate 110 may be sized and configured to be secured mechanically to the junction box 130 in the same manner as a prior-art junction-box cover or hard-wired light fixture. Base plate 110 includes at least two support rails 115, and at least two electrical source contacts (not shown in this figure; refer to FIG. 3). The electrical source contacts are partially concealed by the support rails to reduce the risk that an individual will inadvertently come into contact with them and be injured.

Mating plate 120 is shown slightly separated from base plate 110, but in use, it would be engaged directly thereto. (Engagement features and electrical contacts of the mating plate are not shown in this view.) Mating plate 120 further comprises a plurality of mounting features 125 that are configured to be coupled to a lamp fixture, such as a prior-art lamp fixture 160. For such use, mounting features 125 may usefully be configured to emulate the mounting features 135 of junction box 130. In effect, the base plate 110 and corresponding mating plate 120 of an embodiment may be interposed between a prior-art junction box 130 and a prior-art light fixture 160. Since the mating plate 120 may be decoupled from the base plate 110, the light fixture 160 may be removed from the wall or ceiling mounting surface and replaced with a different style or configuration of light fixture (which may be provided with its own mating plate that is compatible with the mounting features of the base plate).

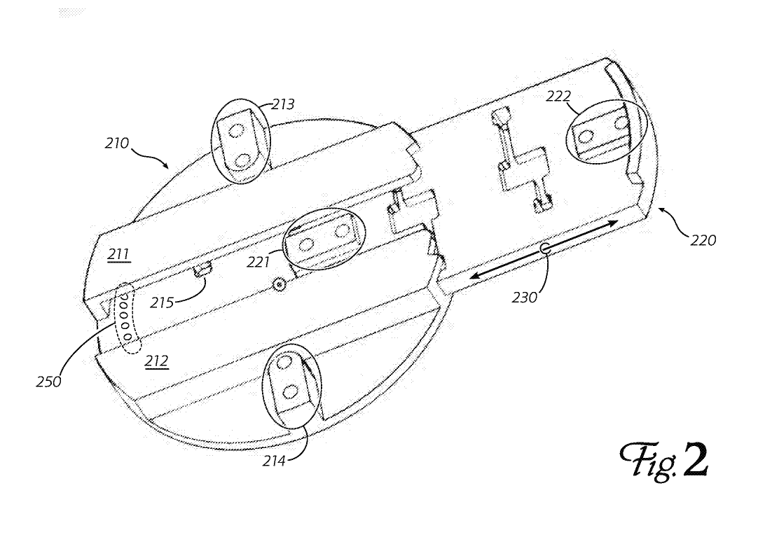

FIG. 2 is a view of a base plate 210 according to an embodiment, partially engaged to a mating plate 220 according to a compatible embodiment. The support rails 211, 212 of the base plate are visible, as are the mounting lugs 213, 214 by which the base plate may be secured to a junction box. A portion of one electrical contact 215 of the base plate is also visible from this angle, but the contacts are mostly concealed. Mating plate 220 slides into the support rails in the direction shown at 230, and when fully engaged, electrical contacts are made. A light fixture or other electrical device secured to mounting holes 221, 222 of the mating plate can receive power (and potentially other electrical signals) by connecting to the contacts on the mating plate. An embodiment may include a plurality of low-voltage contacts (250) which permit control, communication or other signals to pass across the base-plate/mating-plate boundary. As shown here, these low-voltage contacts need not be concealed, since the signals connected thereto pose no safety risk.

FIG. 3 shows components of an embodiment separated more fully from one another. A base plate 310 is sized and configured to mount as a cover to a prior-art junction box 130. A mating plate 320 can couple reversibly to base plate 310, engaging both mechanically or structurally, and electrically. Electrical contacts 312, 322, 323 and 324 fit in openings in mating plate 320, and when the plates are engaged, the contacts touch corresponding contacts in the base plate (not shown) to establish electrical circuits.

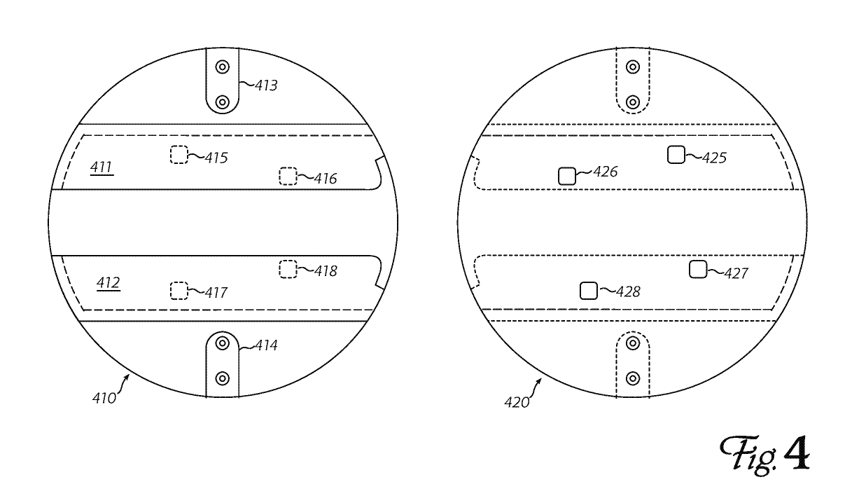

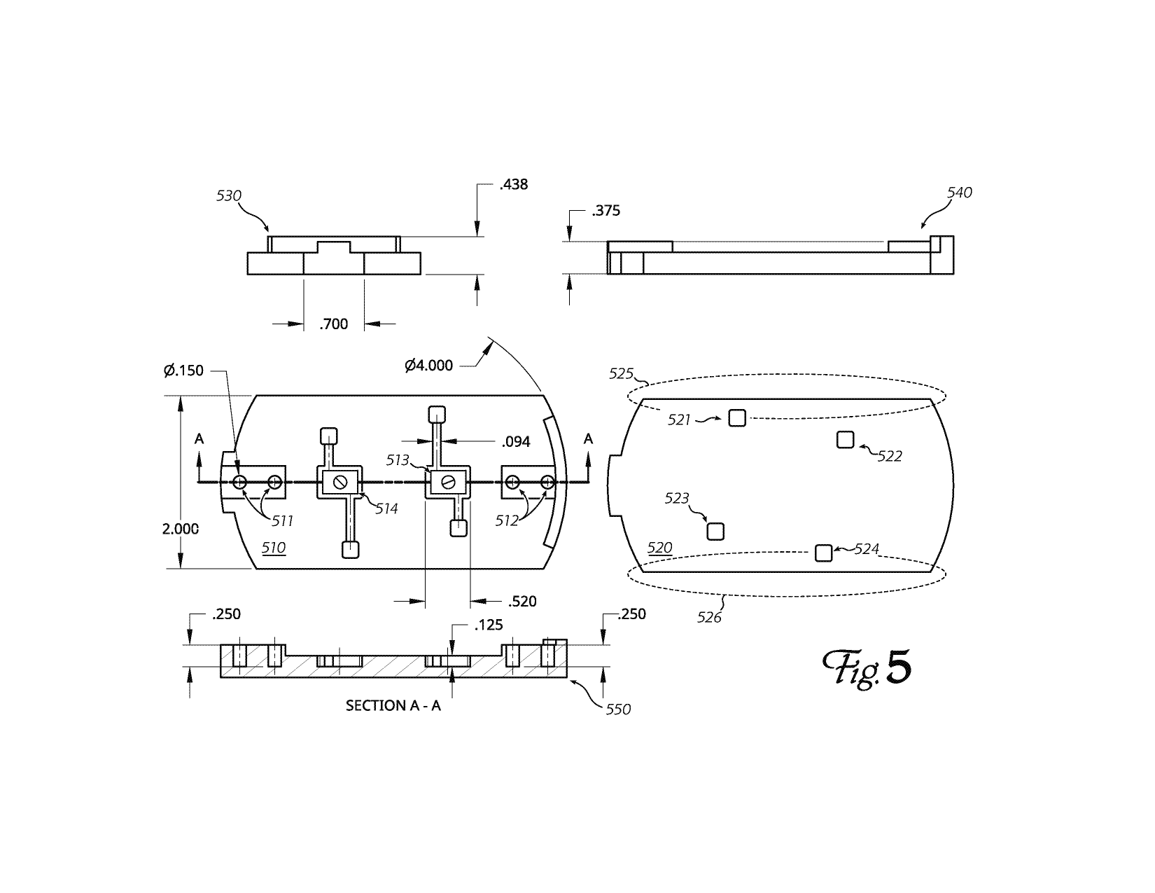

FIG. 4 shows top and bottom plan views of a base plate according to an embodiment of the invention. A first surface of the base plate 410 is exposed and visible when secured to a junction box (not shown). This surface may be thought of as the “front” of the base plate. There are two support rails 411, 412 which engage complementary features of a mating plate (see FIG. 5). Two mounting bosses 413, 414 have holes that correspond to holes on a junction box; screws through some of these holes may be used to secure the base plate. A plurality of electrical source contacts 415-418 are staggered across this front surface, but partially concealed behind support rails 411 and 412 (they may be visible if the base plate is viewed from an angle, as shown in FIG. 2). Staggering the contacts in this manner permits the electrical source connections to be polarized (i.e., they connect to corresponding contacts on the mating plate in a deterministic way). Partially concealing the contacts makes them less likely to injure a user through inadvertent contact when the contacts are live.

A second surface of the base plate 420 may be considered the “back” of the plate: when installed on a junction box, this surface is not exposed and visible. There may be fewer features on this surface, but the electrical source contacts connect through to connection points 425-428 (e.g., solderless push-in terminals or screw terminals) to which powered conductors available within the junction box may be connected. The back-side connection points may be modeled after known electrical wiring terminations, such as the “push-in” terminations mentioned in U.S. Patent Application Publication No. US2010/0304624A1 by Montalbano et al.

FIG. 5 shows several views of a mating plate according to an embodiment of the invention. (Dimension indicators refer to a specific implementation, but an embodiment may be sized or shaped differently.) This mating plate is configured to couple to the base plate shown in FIG. 4. On one surface 510, features that interact with the prior-art light fixture are visible. For example, 511 and 512 are mounting holes by which the light fixture can be secured to the mating plate. 513 and 514 are electrical terminals (screw terminals) to provide power to the fixture. As with connection points 425-428 shown in FIG. 4, these terminals may use any convenient, conventional connection mechanism. The electrical terminals connect through to a plurality of contacts which are most easily seen on the obverse surface 520 (contacts staggered at 521, 522, 523, 524). The long sides of the mating plate (circled at 525, 526) are engagement features that slide into the rails of a corresponding base plate, as shown in FIG. 2.

This figure also presents side, end and section views (530, 540, 550 respectively) illustrating that an embodiment may have a complex profile and/or holes and depressions.

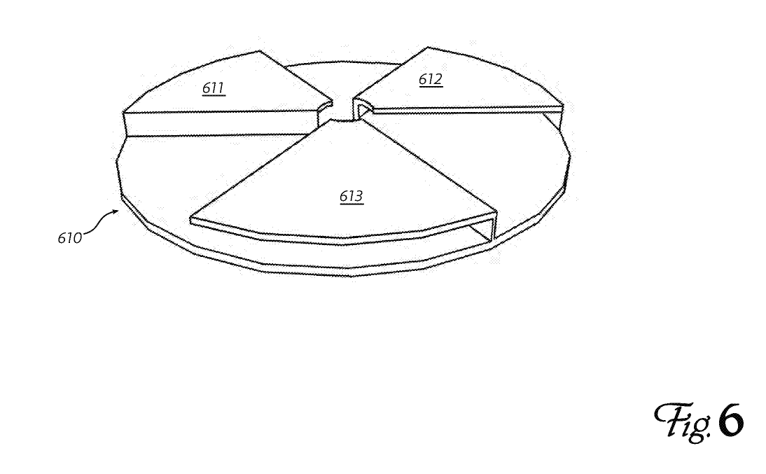

FIG. 6 shows the front of a base plate 610 according to another embodiment (the back of the plate may be similar to that of FIG. 4, 420, although the source contact locations will likely be different). In this embodiment, support rails 611, 612, 613 are roughly triangular and placed radially around the circular plate. A corresponding mating plate would have similarly-positioned engagement features and would be connected to base plate 610 by a rotating motion, rather than a sliding motion as shown in earlier embodiments. However, apart from this difference, the embodiments are similar: there are a plurality of support rails, a plurality of source contacts (preferably hidden), and a plurality of source connections for wiring the base plate to mains power. The corresponding mating plate (not shown) would have a plurality of engagement features for mating to the support rails, a plurality of load contacts that connect to the source contacts when the mating plate is engaged, and a plurality of load connections to supply power to a lamp or other device. The base plate is configured to be secured to a prior-art junction box, and the mating plate is configured to be secured to a prior-art light fixture. Then, when the base plate is engaged to the mating plate (here, by a rotating motion), the light fixture will be supported mechanically and coupled through electrically to a supply voltage. This embodiment may be engaged by a partial turn (e.g., a 60° turn or a 90° turn, depending on the number and arrangement of support rails), while other similar embodiments may use a multi-turn threaded engagement structure.

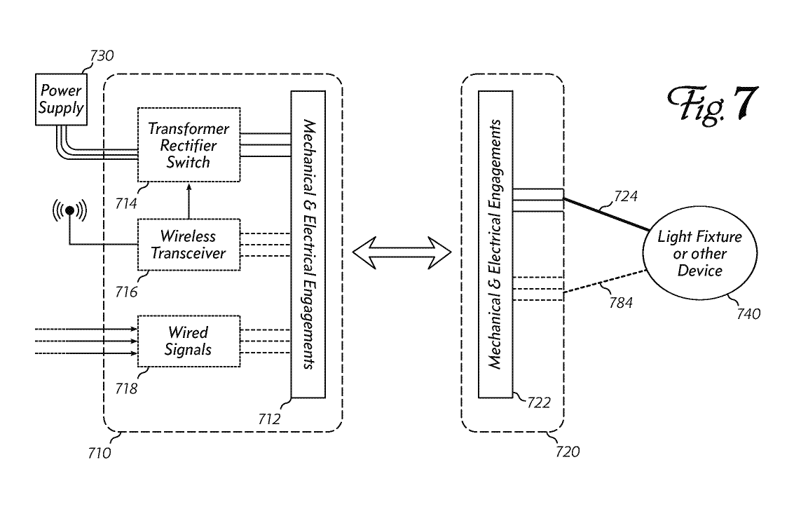

FIG. 7 is a structural block diagram showing features that are (or may be) part of an embodiment of the invention. The two principal elements are a base module 710 and a mating module 720. The base module 710 comprises mechanical and electrical engagement elements 712, and may include a power control or modification element 714, which may change a voltage level of the supply 730, convert from alternating current (“AC”) to direct current (“DC”) or switch the power on or off. The base may include a wireless transceiver 716, such as a Bluetooth® or WiFi radio, which may communicate with other control systems such as a computer, cellular phone or remote control. For example, a software application (“app”) on a smartphone may communicate with wireless transceiver 616 to cause the power control element 714 to turn a light on or off. Some base modules may also accept wired signals, such as Ethernet, serial, RS-485 or DMX (“digital multiplex,” a lighting-control network) through a wired-signal interface 718.

The base module 710 couples reversibly to the mating module 720 through the corresponding mechanical and electrical engagement elements 722, and the power 724 (and optionally, the low-voltage communication signals 784) are delivered to a light fixture or other device, 740, which is secured to mating module 720 and coupled to the base module 710.

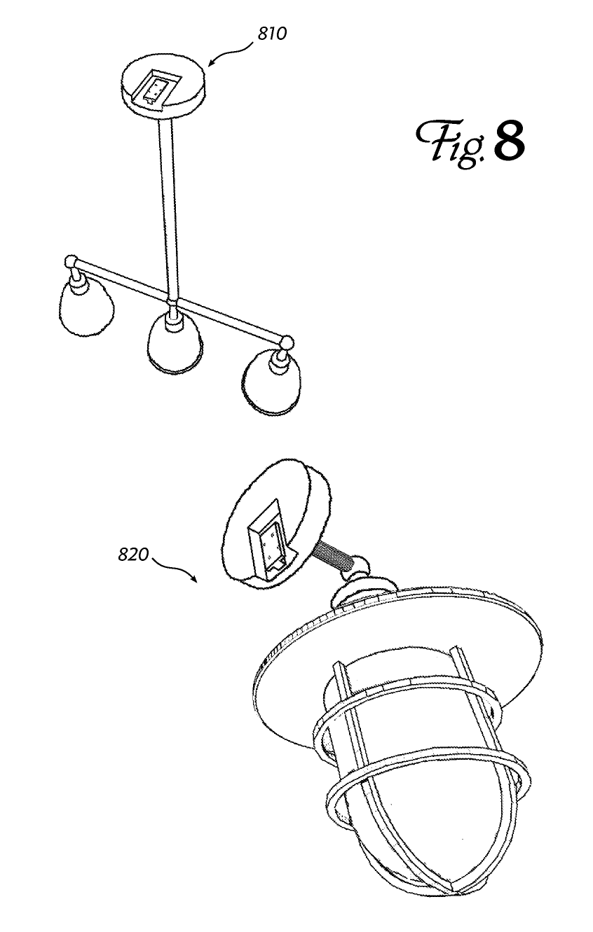

FIG. 8 shows two sample light fixtures secured to mating plates: 810 is a pendant-style lamp that would hang from a ceiling-mounted base plate, while 820 is a sconce-style lamp that would be secured to a base plate mounted on a wall.

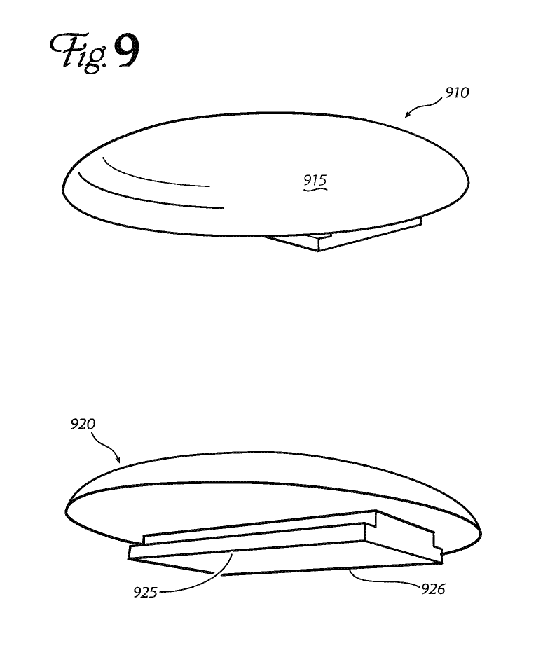

FIG. 9 shows two views of a blank cover plate or escutcheon that may be used to conceal a base plate that is not being used to support and supply power to a light fixture. The exterior view 910 may present a smooth lenticular outside surface 915. The finish may be glossy or matte, and may be colored or prepared accept a standard paint finish. The back side 920 comprises mechanical engagement features 925, 926 which are compatible with the corresponding features of a mating plate. However, no electrical contacts (power or signal) are necessary.

In one embodiment, an escutcheon-style blank plate may be constructed with electrical contacts and built-in, low-intensity lights such as light-emitting diodes (“LEDs”) or electroluminescent (“EL”) panels. Such a mating plate may function as low-profile lighting, for example as a night-light. This embodiment is best regarded as an ordinary light fixture, where the light is simply very small and unobtrusive.

The mating plate may comprise a reel or spool of flexible multi-conductor cable, which may be used to supply power to, and to suspend, a pendant lamp. The mating plate may also be secured to an electrical device such as a ceiling fan, and the fan may be suspended from a base plate installed in the ceiling of a room. The features of a mating plate according to an embodiment of the invention may be built into a complete light fixture or other electrical device, so that the device itself can be mated to a base plate, similarly to the way a corded electrical appliance can be plugged into a standard receptacle. Thus, in some embodiments, the mating plate may include an entire light fixture.

The applications of the present invention have been described largely by reference to specific examples and in terms of particular allocations of functionality to certain hardware and/or software components. However, those of skill in the art will recognize that safe, easily-interchanged light fixtures can also be achieved by structures that distribute the functions of embodiments of this invention differently than herein described. Such variations and implementations are understood to be captured according to the following claims.

We claim:

1. A multi-part mating adapter comprising:
a base plate configured to mount as a cover to a junction box, said base plate having at least two support rails and at least two electrical source contacts partially concealed by the at least two support rails; and
a mating plate configured to reversibly engage the base plate by at least two engagement features corresponding to the at least two support rails, said mating plate having at least two electrical load contacts positioned to couple to the at least two electrical source contacts when the mating plate is engaged to the base plate, wherein
the mating plate further comprises a plurality of mounting features to couple the mounting plate to a lamp fixture.

2. The multi-part mating adapter of claim 1 wherein the plurality of mounting features emulate sizes and locations of corresponding mounting features of the junction box.

3. The multi-part mating adapter of claim 1 wherein the plurality of mounting features are different from sizes and locations of mounting features by which the base plate mounts to the junction box.

4. The multi-part mating adapter of claim 1 wherein the mating plate engages the base plate by a linear sliding motion.

5. The multi-part mating adapter of claim 1 wherein the mating plate engages the base plate by a circular rotating motion.

6. The multi-part mating adapter of claim 5 wherein the mating plate engages the base plate by a threaded coupling.

7. The multi-part mating adapter of claim 1 wherein the mating plate further comprises:
a retractable spool of multi-conductor cable, wherein electrical conductors of the multi-conductor cable are electrically coupled to the at least two electrical load contacts.

8. The multi-part mating adapter of claim 1, further comprising:
an electrical-level adjuster to convert an input power level to an output power level, electrical conductors at said output power level in electrical connection with the at least two electrical source contacts.

9. The multi-part mating adapter of claim 1 wherein the base plate comprises at least two signal source contacts and wherein
the mating plate comprises at least two corresponding signal sink contacts, said signal sink contacts positioned to couple to the at least two signal source contacts when the mating plate is engaged to the base plate.

10. The multi-part mating adapter of claim 1 further comprising:
an escutcheon adapted to mount to and substantially cover an exterior surface of the mating adapter.

11. The multi-part mating adapter of claim 1 further comprising:
a blank mating adapter configured to connect to the mounting plate using engagement features similar to the engagement features of the mating adapter, wherein
the blank mating adapter lacks electrical load contacts.

12. An apparatus comprising:
a junction box cover having mounting rails that are exposed and visible when the junction box cover is secured to a junction box, and electrical pass-throughs to carry electrical power through the junction box cover from source conductors inside a junction box to concealed contacts outside the junction box; and
a mating plate adapted to engage the mounting rails of the junction box cover, said mating plate having electrical pass-throughs to carry electrical current through the mating plate from load contacts on a side of the mating plate adjacent the concealed contacts outside the junction box, to another side of the mating plate.

13. The apparatus of claim 12, wherein the mating plate further comprises mounting features configured to secure the mating plate to a light fixture.

14. The apparatus of claim 12, wherein the mating plate further comprises a light fixture, said light fixture electrically connected to the electrical pass-throughs of the mating plate.

15. The apparatus of claim 12, wherein the mating plate reversibly engages the junction box cover by a linear sliding motion.

16. The apparatus of claim 12, wherein the mating plate reversibly engages the junction box cover by a rotating motion.

17. A system comprising:
a base module having electrical and mechanical engagement features; and
a mating module having complementary electrical and mechanical engagement features, so that the mating module can be reversibly coupled to the base module by the mechanical engagement features and, when so coupled, the electrical engagement features establish electrical connectivity from the base module to the mating module.

18. The system of claim 17, wherein the base module further comprises a power conditioning module.

19. The system of claim 17, wherein the base module further comprises a wireless transceiver.

20. The system of claim 17, wherein the base module further comprises a wired signal interface.
